(19) United States
(12) Patent Application Publication
(10) Pub. No.: US 2018/0314240 A1
(43) Pub. Date: Nov. 1, 2018

(54) FLEXIBLE HIERARCHICAL MODEL FOR MONITORING DISTRIBUTED INDUSTRIAL CONTROL SYSTEMS

(71) Applicant: Honeywell International Inc., Morris Plains, NJ (US)

(72) Inventors: Arun Velagapalli, Tucker, GA (US); Thomas M. Mesic, London (CA)

(21) Appl. No.: 15/582,232

(22) Filed: Apr. 28, 2017

(51) Int. Cl. G05B 19/418

(52) U.S. Cl. CPC G05B 19/41835; G05B 2219/40444

(57) ABSTRACT

This disclosure describes an apparatus and method for monitoring distributed industrial control systems using a flexible hierarchical model. A method includes providing, a plurality of hierarchically-organized industrial control devices in an industrial control network. The method includes executing, by each of a plurality of the industrial control devices, a publisher application or a subscriber application that is associated with a hierarchical level of the industrial control network. The method includes associating each publisher application or subscriber application with an application hierarchy property that identities the associated hierarchical level in the industrial control network. The method includes executing a process, by one of the industrial control devices according to the application hierarchy properties.

### TECHNICAL FIELD

This disclosure relates generally to network security. More specifically, this disclosure relates to an apparatus and method for data publishing and replication, including but not limited to use in cyber-security systems.

### BACKGROUND

Processing facilities are often managed using industrial process control and automation systems. Conventional control and automation systems routinely include a variety of networked devices, such as servers, workstations, switches, routers, firewalls, safety systems, proprietary real-time controllers, and industrial field devices. Often times, this equipment comes from a number of different vendors. In industrial environments, cyber-security is of increasing concern, and unaddressed security vulnerabilities in any of these components could be exploited by attackers to disrupt operations or cause unsafe conditions in an industrial facility. To detect or report a threat, it is often useful to efficiently publish data from database tables.

### SUMMARY

This disclosure provides an apparatus and method for monitoring distributed industrial control systems using a flexible hierarchical model. A method includes providing a plurality of hierarchically-organized industrial control devices in an industrial control network. The method includes executing, by each of a plurality of the industrial control devices, a publisher application or a subscriber application that is associated with a hierarchical level of the industrial control network. The method includes associating each publisher application or subscriber application with an application hierarchy property that identifies the associated hierarchical level in the industrial control network. The method includes executing a process, by one of the industrial control devices according to the application hierarchy properties.

Disclosed embodiments include a first industrial control device among a plurality of hierarchically-organized industrial control devices in an industrial control network, comprising a controller and a memory, configured to perform processes as described herein, Disclosed embodiments also include anon-transitory machine-readable medium encoded with executable instructions that, when executed, cause one or more controllers of a first industrial control device among a plurality of hierarchically-organized industrial control devices in an industrial control network to perform processes as disclosed herein.

In various embodiments, each application hierarchy property also includes an order index value that uniquely identifies the associated publisher application or subscriber application among other publisher applications or subscriber applications at the same hierarchical level. In various embodiments, the process is a replication process that specifies data replication between publisher applications and subscriber applications based on the application hierarchy properties. In various embodiments, the process is creating a logical data map of the publisher application and subscriber applications throughout the industrial control network based on the application hierarchy properties of each of the publisher applications or subscriber applications. In various embodiments, each publisher application or subscriber application also includes connection information that identities connections between publisher applications and subscriber applications according to the associated application hierarchy properties, and the logical data map including connections between publisher applications and subscriber applications according to the connection information. In various embodiments, each publisher application includes an application hierarchy property P_{q,j} indicating that the publisher application is at hierarchical level q and has an order index j. In various embodiments, each subscriber application includes an application hierarchy property S_{q,j} indicating that the subscriber application is at hierarchical level q and has an order index j.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates a flexible hierarchical model of an industrial control network for monitoring a distributed industrial control system; and

FIG. 3 illustrates a process in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

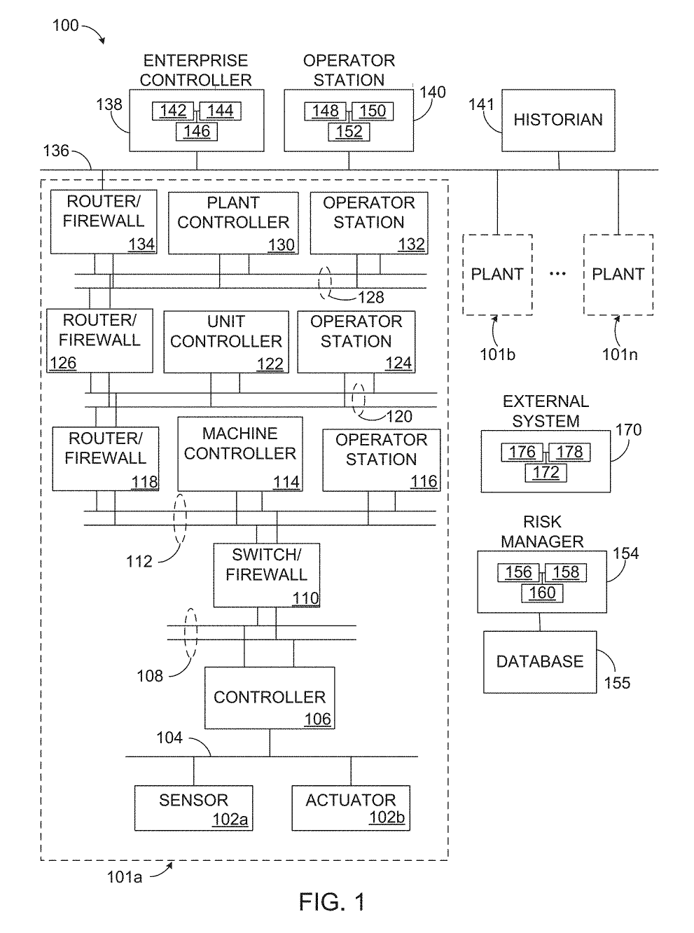

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n, Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102.a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multi variable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112.

The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100, Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected in or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102h).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a. MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148, Each of the operator stations 116, 124, 132, 140 could also include at least one network interface 152, such as one or more Ethernet interfaces or wireless transceivers.

As noted above, cyber-security is of increasing concern with respect to industrial process control and automation systems, and it is often important to publish cyber-security and other data between systems. In a data replication application, sets of data records are sent from publishers to subscribers. The subscriber may or may not be able to add, delete or modify the data that is received from a publisher based on the type of replication. In order to logically segregate a subscriber/publisher based on some functionality, a properly related to the “application hierarchy” can be used.

The property should support attributes that can reveal information about a subscriber or a publisher such as its associated level in a hierarchy, location, role, etc.

Based on such a property, the role of a participating entity can be defined regarding whether it is a publisher, subscriber, or both at the same time.

Disclosed embodiments solve the problem of attribution of a property to entities that participate in data exchange at any level in the hierarchy of an application. When such a property is configured, more application specific restrictions can be performed, such as abstracting data from a lower level to a higher level, without interference of the data transfer operation.

In an Industrial Control System network, the data may be sent and received across various layers (levels) of the application. This feature provides the ability to distinguish between different types of senders/receivers and to possibly define rules that can be enforced to abstract or hide data from one level to other. Disclosed embodiments can be used in conjunction with commercial software and services, including but not limited to the HONEYWELL Industrial Enterprise Risk Manager (ERM) software application, acting as the data replication subscriber, and the commercially available HONEYWELL Industrial Cybersecurity Risk Manager (RM) software application, to act as a data replication publisher.

The processes and results described herein can be accomplished (among other ways) using a risk manager 154. Among other things, the risk manager 154 supports a technique for replication of identity-derived primary keys without range restrictions.

In this example, the risk manager 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory or Flash memory. Each network interface 160 could represent an Ethernet interface, wireless transceiver, or other device facilitating external communication. The functionality of the risk manager 154 could be implemented using any suitable hardware or a combination of hardware and software/firmware instructions. In some embodiments, the risk manager 154 includes, or is communication with, a database 155. The database 155 denotes any suitable structure facilitating storage and retrieval of information.

Disclosed embodiments enable the efficient publishing of risk manager data or other data from a system such as the risk manager 154, and allow identification of published data based on device hierarchy. The analysis and reporting can also or alternatively be accessed or performed, in some cases, by an external system 170. In this example, the external system 170 includes one or more processing devices 176; one or more memories 178 for storing instructions and data used, generated, or collected by the processing device(s) 176; and at least one network interface 172, Each processing device 176 could represent a microprocessor, microcontroller, digital signal process, field programmable gate array, application specific integrated circuit, or discrete logic. Each memory 178 could represent a volatile or non-volatile storage and retrieval device, such as a random access memory or Flash memory. Each network interface 172 could represent an Ethernet interface, wireless transceiver, or other device facilitating external communication. The functionality of the external system 170 could be implemented using any suitable hardware or a combination of hardware and software/firmware instructions. The external system 170 can be, for example, a stand-alone data processing system, a mobile device, an external server or enterprise system, or otherwise. The exemplary structure of the external system 170 described above is not intended to limit the structure or function of the devices that could be used to implement the external system 170. In specific embodiments, one or more external systems 170 act as the “subscribers” to which data is to be published as described herein.

Although FIG. 1 illustrates one example of an industrial process control and automation system IOU, various changes may be made to FIG. 1. For example, a control and automation system could include any number of sensors, actuators, controllers, servers, operator stations, networks, risk managers, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100, This is for illustration only. In general, control and automation systems are highly configurable and can be configured in any suitable manner according to particular needs. In addition, FIG. 1 illustrates an example environment in which the functions of the risk manager 154 can be used. This functionality can be used in any other suitable device or system.

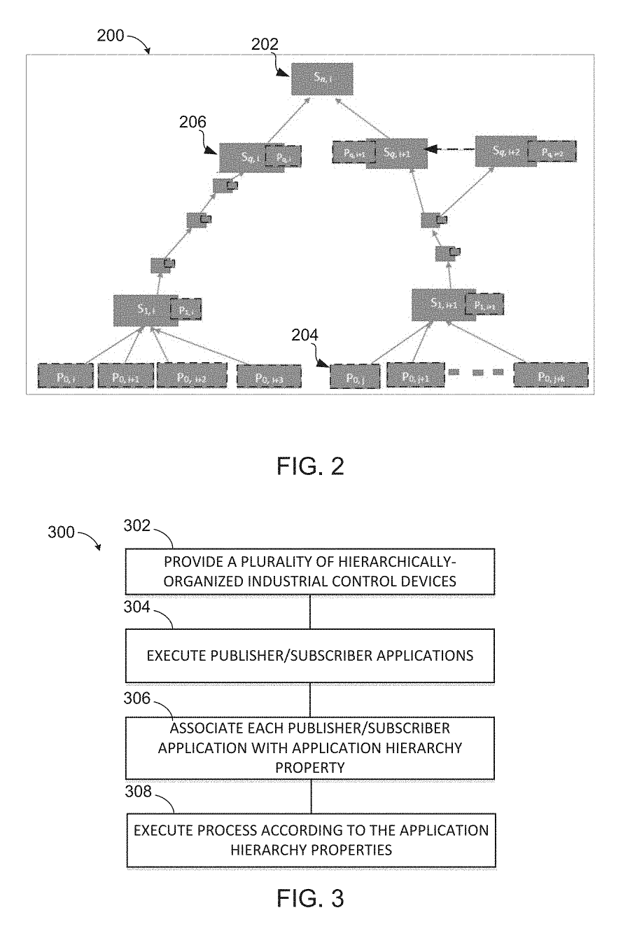

FIG. 2 illustrates a flexible hierarchical model of an industrial control network 200 for monitoring a distributed industrial control system, such as that of FIG. 1, in accordance with disclosed embodiments. In this figure, boxes with a heavy dashed-line border indicate publisher sites, and boxes without a heavy-dashed line border indicate subscriber sites. A dashed-line arrow indicates a connection to the same level, while solid arrows indicate a connection to a higher hierarchical level.

A data publisher is a site where data is generated to be published to other sites. A data subscriber is a site that collects data from publishers. The “site” can be a system or device within the industrial control system, and can be implemented as an application executing on such a system or device. A given physical system or device may implement multiple subscriber/publisher applications. Any of the elements of FIG. 1 can act as publisher or subscriber site. Each of the subscriber sites and publisher sites has an associated application hierarchy property.

P_{q,j} is an application hierarchy property associated with a data publisher at level q with order index j. S_{q,j} is an application hierarchy property associated with a data subscriber at level q with order index j. Note that the level q should be the same for different sites across the same level, while the order index j distinguishes between sites on the level. Index ranges can be separate when publishers or subscribers are in different networks, divisions, etc. For example, a utility company may set up subset (Q) of publishers from various parts of city A to one subscriber A, and other subset (M) of publishers from other parts of city A to other subscriber B. The index in such a scenario for subset Q may be P_{0,1}, P_{0,2}, etc., while indices for publishers of subset M may be P_{0,256}, P_{0,257}, etc. The order indices do not have to be continuous; as long as they are distinct and come from same level, other sites and system will be able to distinguish between them.

Note that many devices can function as both a publisher site and a subscriber site, as shown at site 206, The highest-level site 202 in the hierarchy (level n), in this example, is a subscriber site only, since there is no higher level to which data should be published. Similarly, the lowest-level sites in the hierarchy (level 0), such as 204 in this example, are publisher sites only, since there are no lower-level sites from which data should be subscribed. The “application hierarchy property” therefore indicates the hierarchical level of the publisher/subscriber application, which also indicates the hierarchical level of the device upon which the application is executing. The order index value in a level is unique to each application, and so a single device can execute several applications, each having a unique order index value.

A data table T is maintained at each participating data node (site) that houses the data for that publisher/subscriber and also maintains the application hierarchy properties of that site, such as being stored in an appropriate memory or database. The table provides the context such as level in a hierarchy to the application that is consuming the data, as indicated by the application hierarchy property.

An application on a data processing system, such as risk manager 154 or external system 170, can perform control operations based on the application hierarchy properties associated in data table T.

For example, a replication process may be that only a set of chosen tables should be replicated from level q to level q+1 in the industrial control network hierarchy. As illustrated in FIG. 2, each publisher/subscriber node represents a publisher/subscriber data application that contains a table T.

For example, assume that an abstract view of data at the lowest level in a hierarchy of an organization needs attention from a top-level executive actor. By using flexible site hierarchies as represented by the application hierarchy properties, processes or rules can be defined to provide a seamless data pipe from the lowest level in the industrial control network to entities in other layers by abstraction of data at each level in the hierarchy.

For example, a CEO of a company may simply be interested in looking at a Boolean value that shows if all the entities in various plants across various parts of the world are in a good state or bad state with respect to threat analysis. In such scenario, the various “sites” that report to a central node can be considered as sensors in an Industrial Internet of Things (IIOT) paradigm. Disclosed embodiments provide a level based control for such IIOT approach by adding properties for each sensor.

In this example, the CEO could run a process to collect state data from all publishers, or all publishers at a given level that includes a hierarchical indicator based on the application hierarchy properties. The process can select data as appropriate from the publishers based on the application hierarchy properties. Similarly, the application hierarchy properties can be used to generate a logical data map of the publishers and subscribers throughout the industrial control network/system.

FIG. 3 illustrates a process 300 in accordance with disclosed embodiments, as performed by one or more publisher systems and a subscriber system. The publisher “systems” and subscriber “system,” can, in some cases, be separate applications or application instances on the same physical system. The publisher sites and subscriber sites can be implemented, for example, as a risk manager 154, an external system 170, any other device or system as described above, or in other data processing system(s), and by the applications executing on one or more of those devices.

A plurality of hierarchically-organized industrial control devices is provided in an industrial control network (302).

A plurality of the industrial control devices each executes a publisher application or a subscriber application that is associated with a hierarchical level of the industrial control network (304).

Each publisher application or subscriber application is associated with an application hierarchy property that identifies the associated hierarchical level in the industrial control network (306). The application hierarchy property can also include an order index value that uniquely identifies the associated publisher application or subscriber application among other publisher applications or subscriber applications at the same hierarchical level. Each publisher application or subscriber application can also include connection information that identifies connections between publisher applications and subscriber applications according to the associated application hierarchy properties.

One or more of the plurality of the industrial control devices executes a process according to the application hierarchy properties (308).

In some embodiments, the process can be a replication process that specifies data replication between publisher applications and subscriber applications based on the application hierarchy properties, such as only replicating data between a publisher application at a first hierarchical level and a subscriber application at a second hierarchical level.

In some embodiments, the process can be creating a logical data map of the publishers and subscribers throughout the industrial control network/system based on the application hierarchy properties of each of the publisher applications or subscriber applications. The logical data map can include connections between publisher applications and subscriber applications according to the connection information.

Disclosed embodiments provide a number of technical advantages and device improvements. Techniques such as those disclosed herein provide particular advantages in the context of industrial control systems by enabling seamless integration of datasets from various levels across an organization. Using disclosed processes, an encapsulation or abstraction can be performed on a level-based approach in an Industrial Internet of Things paradigm. A controlled and layered architecture can be created such that stake-holders at higher levels of an organization may view only an absolute abstract value to determine the entire state of source network.

Disclosed embodiments provide flexibility in applications that require monitoring of data from lowest level where the data is generated to highest level where data can be evaluated. Using this property, only minimal changes in an application are required to apply rules of abstraction. In other words, the same monitoring application can be used across the layers of hierarchy by properly defining the rules and properties that define the functionality at each level. This reduces the cost of development of a new application.

Note that the risk manager 154, the publisher systems, the subscriber systems, and/or the other processes, devices, and techniques described herein could use or operate in conjunction with any combination or all of various features described in the following previously-filed patent applications (all of which are hereby incorporated by reference):
U.S. patent application Ser. No. 14/482,888 entitled “DYNAMIC QUANTIFICATION OF CYBER-SECURITY RISKS IN A CONTROL SYSTEM”;
U.S. Provisional Patent Application No. 62/036,920 entitled “ANALYZING CYBER-SECURITY RISKS IN AN INDUSTRIAL CONTROL ENVIRONMENT”;
U.S. Provisional Patent Application No. 62/113,075 entitled “RULES ENGINE FOR CONVERTING SYSTEM-RELATED CHARACTERISTICS AND EVENTS INTO CYBER-SECURITY RISK ASSESSMENT VALUES” and corresponding non-provisional U.S. patent application Ser. No. 14/871,695;
U.S. Provisional Patent Application No. 62/113,221 entitled “NOTIFICATION SUBSYSTEM FOR GENERATING CONSOLIDATED, FILTERED, AND RELEVANT SECURITY RISK-BASED NOTIFICATIONS” and corresponding non-provisional U.S. patent application Ser. No. 14/871,521;
U.S. Provisional Patent Application No. 62/113,100 entitled “TECHNIQUE FOR USING INFRASTRUCTURE MONITORING SOFTWARE TO COLLECT CYBER-SECURITY RISK DATA” and corresponding non-provisional U.S. patent application Ser. No. 14/871,855;
U.S. Provisional Patent Application No. 62/113,186 entitled “INFRASTRUCTURE MONITORING TOOL FOR COLLECTING INDUSTRIAL PROCESS CONTROL AND AUTOMATION SYSTEM RISK DATA” and corresponding non-provisional U.S. patent application Ser. No. 14/871,732;
U.S. Provisional Patent Application No. 62/113,165 entitled “PATCH MONITORING AND ANALYSIS” and corresponding non-provisional U.S. patent application Ser. No. 14/871,921;
U.S. Provisional Patent Application No. 62/113,152 entitled “APPARATUS AND METHOD FOR AUTOMATIC HANDLING OF CYBER-SECURITY RISK EVENTS” and corresponding non-provisional U.S. patent application Ser. No. 14/871,503;
U.S. Provisional Patent Application No. 62/114,928 entitled “APPARATUS AND METHOD FOR DYNAMIC CUSTOMIZATION OF CYBER-SECURITY RISK ITEM RULES” and corresponding non-provisional U.S. patent application Ser. No. 14/871,605;
U.S. Provisional Patent Application No. 62/114,865 entitled “APPARATUS AND METHOD FOR PROVIDING POSSIBLE CAUSES, RECOMMENDED ACTIONS, AND POTENTIAL IMPACTS RELATED TO IDENTIFIED CYBER-SECURITY RISK ITEMS” and corresponding non-provisional U.S. patent application Ser. No. 14/871,814; and
U.S. Provisional Patent Application No. 62/114,937 entitled “APPARATUS AND METHOD FOR TYING CYBER-SECURITY RISK ANALYSIS TO COMMON RISK METHODOLOGIES AND RISK LEVELS” and corresponding non-provisional U.S. patent application Ser. No. 14/871,136; and
U.S. Provisional Patent Application No. 62/116,245 entitled “RISK MANAGEMENT IN AN AIR-GAPPED ENVIRONMENT” and corresponding non-provisional U.S. patent application Ser. No. 14/871,547.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
providing a plurality of hierarchically-organized industrial control devices in an industrial control network;
executing, by each of a plurality of the industrial control devices, a publisher application or a subscriber application that is associated with a hierarchical level of the industrial control network;
associating each publisher application or subscriber application with an application hierarchy property that identifies the associated hierarchical level in the industrial control network; and
executing a process, by one of the industrial control devices according to the application hierarchy properties.

2. The method of claim 1, wherein each application hierarchy property also includes an order index value that uniquely identifies the associated publisher application or subscriber application among other publisher applications or subscriber applications at the same hierarchical level.

3. The method of claim 1, wherein the process is a replication process that specifies data replication between publisher applications and subscriber applications based on the application hierarchy properties.

4. The method of claim 1, wherein the process is creating a logical data map of the publisher application and subscriber applications throughout the industrial control network based on the application hierarchy properties of each of the publisher applications or subscriber applications.

5. The method of claim 1, wherein each publisher application or subscriber application also includes connection information that identities connections between publisher applications and subscriber applications according to the associated application hierarchy properties, and wherein the process is creating a logical data map of the publisher application and subscriber applications throughout the industrial control network based on the application hierarchy properties of each of the publisher applications or subscriber applications, the logical data map including connections between publisher applications and subscriber applications according to the connection information.

6. The method of claim 1, wherein each publisher application includes an application hierarchy property P_{q,j} indicating that the publisher application is at hierarchical level q and has an order index j.

7. The method of claim 1, wherein each subscriber application includes an application hierarchy property S_{q,j} indicating that the subscriber application is at hierarchical level q and has an order index j.

8. A first industrial control device among a plurality of hierarchically-organized industrial control devices in an industrial control network, the first industrial control device comprising:
a controller; and
a memory, the controller configured to:
execute a publisher application or a subscriber application that is associated with a hierarchical level of the industrial control network, wherein each of the plurality of hierarchically-organized industrial control devices also executes a publisher application or a subscriber application that is associated with a hierarchical level of the industrial control network;
associate each publisher application or subscriber application with an application hierarchy property that identifies the associated hierarchical level in the industrial control network; and
execute a process according to the application hierarchy properties.

9. The first industrial control device of claim 8, wherein each application hierarchy property also includes an order index value that uniquely identifies the associated publisher application or subscriber application among other publisher applications or subscriber applications at the same hierarchical level.

10. The first industrial control device of claim 8, wherein the process is a replication process that specifies data replication between publisher applications and subscriber applications based on the application hierarchy properties.

11. The first industrial control device of claim 8, wherein the process is creating a logical data map of the publisher application and subscriber applications throughout the industrial control network based on the application hierarchy properties of each of the publisher applications or subscriber applications.

12. The first industrial control device of claim 8, wherein each publisher application or subscriber application also includes connection information that identifies connections between publisher applications and subscriber applications according to the associated application hierarchy properties, and wherein the process is creating a logical data map of the publisher application and subscriber applications throughout the industrial control network based on the application hierarchy properties of each of the publisher applications or subscriber applications, the logical data map including connections between publisher applications and subscriber applications according to the connection information.

13. The first industrial control device of claim 8, wherein each publisher application includes an application hierarchy property P_{q,j} indicating that the publisher application is at hierarchical level q and has an order index j.

14. The first industrial control device claim 8, wherein each subscriber application includes an application hierarchy property S_{q,j} indicating that the subscriber application is at hierarchical level q and has an order index j.

15. A non-transitory machine-readable medium encoded with executable instructions that, when executed, cause one or more controllers of a first industrial control device among a plurality of hierarchically-organized industrial control devices in an industrial control network to:
execute a publisher application or a subscriber application that is associated with a hierarchical level of the industrial control network, wherein each of the plurality of hierarchically-organized industrial control devices also executes a publisher application or a subscriber application that is associated with a hierarchical level of the industrial control network;
associate each publisher application or subscriber application with an application hierarchy property that identifies the associated hierarchical level in the industrial control network; and
execute a process according to the application hierarchy properties.

16. The non-transitory machine-readable medium of claim 15, wherein each application hierarchy property also includes an order index value that uniquely identifies the associated publisher application or subscriber application among other publisher applications or subscriber applications at the same hierarchical level.

17. The non-transitory machine-readable medium of claim 15, wherein the process is a replication process that specifies data replication between publisher applications and subscriber applications based on the application hierarchy properties.

18. The non-transitory machine-readable medium of claim 15, wherein the process is creating a logical data map of the publisher application and subscriber applications throughout the industrial control network based on the application hierarchy properties of each of the publisher applications or subscriber applications.

19. The non-transitory machine-readable medium of claim 15, wherein each publisher application or subscriber application also includes connection information that identities connections between publisher applications and subscriber applications according to the associated application hierarchy properties, and wherein the process is creating a logical data map of the publisher application and subscriber applications throughout the industrial control network based on the application hierarchy properties of each of the publisher applications or subscriber applications, the logical data map including connections between publisher applications and subscriber applications according to the connection information.

20. The non-transitory machine-readable medium of claim 15, wherein each publisher application includes an application hierarchy property P_{q,j} indicating that the publisher application is at hierarchical level q and has an order index j.
